(19) United States
(12) Patent Application Publication
(10) Pub. No.: US 2010/0032397 A1
(43) Pub. Date: Feb. 11, 2010

(54) Gantry with Adjustable Torsion Leaf Springs

(76) Inventors: Chien-Cheng LIN, Taichung (TW); Pzung-Cheng LIOU, Taichung (TW)

Correspondence Address: Dr. BANGER SHIA, 102 Lindencrest Ct., Sugar Land, TX, 77479-5201, US

(21) Appl. No.: 12/189,155

(22) Filed: Aug. 9, 2008

(51) Int. Cl. B66C 5/02

(52) U.S. Cl. 212/324

(57) ABSTRACT

A gantry with adjustable torsion leaf springs which utilizes a plurality of superposed torsion leaf springs to connect a beam and two supporting members and to absorb the variation quantities of the displacement error of the supporting members. By such arrangements, the absorbed variation quantities can be changed simply by adjusting the amount of the torsion leaf springs, thus meeting the requirements of different machines.

### BACKGROUND OF THE INVENTION

1. Field of the Invention

The present invention relates to a feeding mechanism for a machine, and more particularly to a gantry with adjustable torsion leaf springs.

2. Description of the Prior Art

A conventional gantry comprises a beam both ends of which are fixed with a supporting member, respectively, and linear transmission systems drive the supporting members to move, so as to move the gantry. Therefore, in order to make the whole mechanism move smoothly, the linear transmission systems which connected to the supporting members must move synchronously. However, if the synchronous control error is existed, the structure of the gantry will be distorted, or even the linear transmission systems will be damaged.

Therefore, a gantry A as shown in FIG. 1 appeared in the market, which comprises the beam A1 and two supporting members A2. Both ends of the beam A1 are connected to the supporting members A2 by spring steel blocks A3. The respective supporting members A2 is provided with a plurality of sliding blocks B. The user drives the sliding blocks B to slide along guide rails C, and then the sliding blocks B move the gantry A.

By such arrangements, when the sliding blocks B which connected to the supporting members A2 move asynchronously, the variation quantities of the displacement error of the supporting members A2 will not be imposed on the beam A1, but will be imposed on the spring steel blocks A3 to produce torque values. Since the spring steel blocks A3 can endure the variation quantities of the supporting members A2, they will not cause burden or damage to the beam A1.

However, when the gantry A is used by different users and is used on different machines, the variation quantities of the bearable displacement error of the supporting members A2 are usually different, so that the variation quantities and torque values which the spring steel blocks A3 can endure are different. When manufacturing the spring steel blocks A3 with different torque values according to different requirements, the manufacturing process is complex, and the time of manufacturing the products or delivery is delayed.

The present invention has arisen to mitigate and/or obviate the afore-described disadvantages.

### SUMMARY OF THE INVENTION

The primary objective of the present invention is to provide a gantry with adjustable torsion leaf springs which utilizes a plurality of superposed torsion leaf springs to connect a beam and two supporting members. With the modularized torsion leaf springs, the variation quantities of the bearable displacement error of the supporting members and the torque values which the superposed torsion leaf springs can endure can be adjusted simply by changing the amount of the torsion leaf springs, thus meeting different requirements.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional gantry;

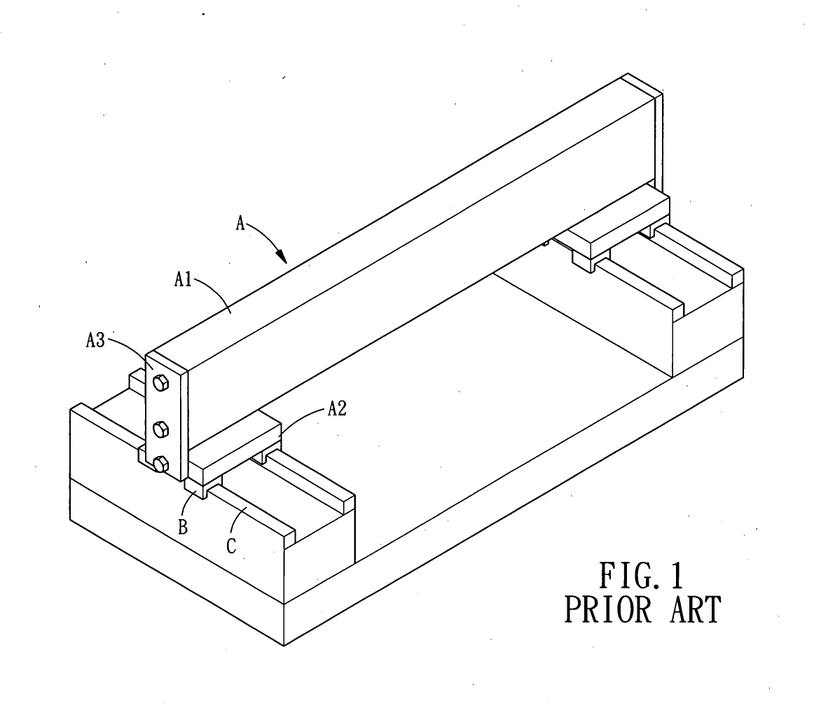

FIG. 2 is a perspective view of a gantry with adjustable torsion leaf springs in accordance with the present invention;

FIG. 3 is a perspective view of the gantry with adjustable torsion leaf springs in accordance with the present invention; and

FIG. 4 is a perspective view of the gantry with adjustable torsion leaf springs in accordance with the present invention.

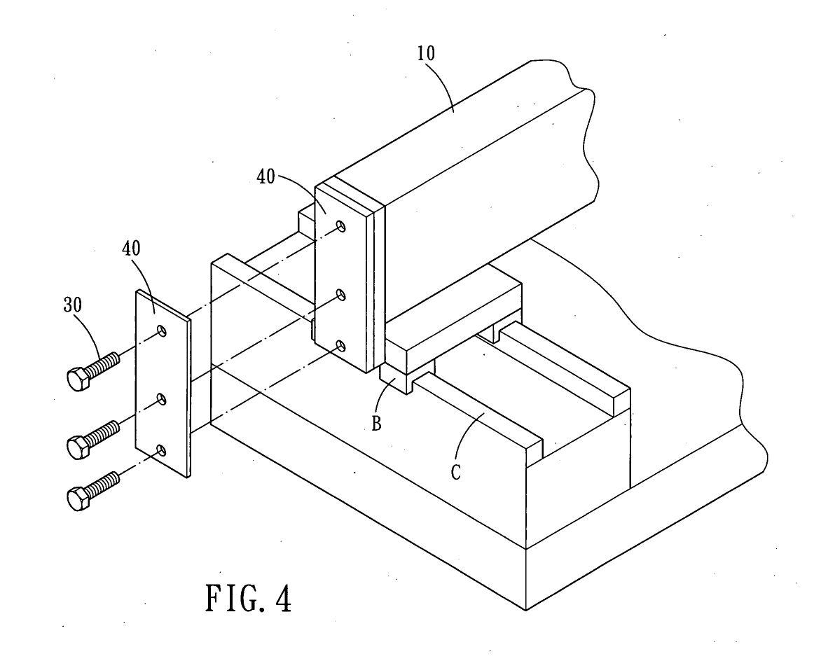

### DETAILED DESCRIPTION OF THE PREFERRED EMBODIMENTS

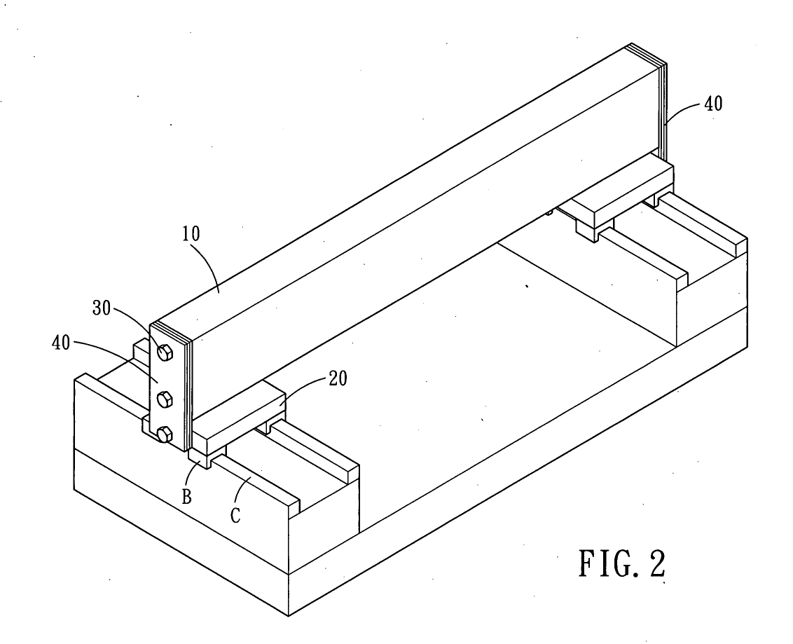

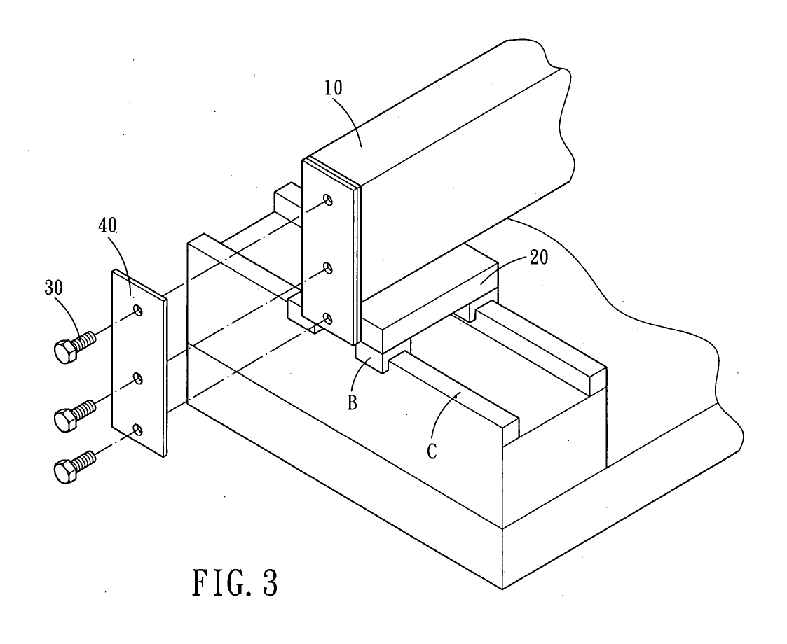

Referring to FIGS. 2 and 3, a gantry with adjustable torsion leaf springs in accordance with the present invention comprises a beam 10 and two supporting members 20.

A plurality of torsion leaf springs 40 are fixed at the supporting members 20 and the beam 10 by screws 30, such that the supporting members 20 are connected to the beam 10 by the torsion leaf springs 40.

Referring to FIG. 2 again, when in use, a linear transmission system, such as, sliding blocks B and a guide rail C, or a linear motor, is disposed at a lower part of each supporting member 20. When the user drives the sliding blocks B to slide along the guide rails C, the sliding blocks B move the gantry.

When the variation quantities of the bearable displacement error of the supporting members 20 are different, the user can disassemble the screws 30 and appropriately reduce or increase the amount of the torsion leaf springs 40 as shown in FIG. 3, so as to change the torque values of the torsion leaf springs 40 after the torsion leaf springs 40 are superposed and the variation quantities which the supporting members 20 can endure.

Thereby, the modularized torsion leaf springs 40 can not only simplify the working process, but also reduce the cost and time according to different kinds of molds and different users' requirements since it is unnecessary to manufacture conventional spring steel blocks A3 with different torque values.

Moreover, in addition to the single sized torsion leaf springs 40 with the same size and thickness as shown in FIG. 3, the torsion leaf springs 40 can also be designed to be multi-sized with different thickness, which can also obtain the above-mentioned effects.

While we have shown and described various embodiments in accordance with the present invention, it should be clear to those skilled in the art that further embodiments may be made without departing from the scope of the present invention.

What is claimed is:

1. A gantry with adjustable torsion leaf springs, which is moved by linear transmission systems, comprising:
a beam; and
two supporting members being connected to the beam by a plurality of superposed torsion leaf springs, and the linear transmission systems being disposed at the supporting members.

2. The gantry with adjustable torsion leaf springs as claimed in claim 1, wherein the torsion leaf springs are fixed at the supporting members and the beam by screws.

3. The gantry with adjustable torque reeds as claimed in claim 1, wherein the torsion leaf springs are single sized.

4. The gantry with adjustable torque reeds as claimed in claim 1, wherein the torsion leaf springs are multi-sized with different thickness.
